(19) United States
(12) Patent Application Publication
(10) Pub. No.: US 2021/0006391 A1
(43) Pub. Date: Jan. 7, 2021

(54) DATA PROCESSING METHOD, CIRCUIT, TERMINAL DEVICE AND STORAGE MEDIUM

(71) Applicant: Shenzhen Goodix Technology Co., Ltd., Shenzhen (CN)

(72) Inventors: Jian WEI, Shenzhen (CN); Dongge WANG, Shenzhen (CN); Ailin SHEN, Shenzhen (CN)

(73) Assignee: Shenzhen Goodix Technology Co., Ltd., Shenzhen (CN)

(21) Appl. No.: 17/029,410

(22) Filed: Sep. 23, 2020

Related U.S. Application Data
(63) Continuation of application No. PCT/CN2018/120732, filed on Dec. 12, 2018.

(51) Int. Cl. H04L 9/06; G06F 21/60; H04L 9/08; G06F 12/0802

(52) U.S. Cl. CPC H04L 9/065; G06F 12/0802; H04L 9/0861; G06F 21/602

(57) ABSTRACT

The present disclosure provides a data processing method, a circuit, a terminal device and a storage medium, which includes: generating a decryption keystream of first data according to a physical start address of the first data before or during reading the first data from a flash; and decrypting the first data through the decryption keystream and writing the decrypted first data into a cache, thus the data decryption delay can be reduced.

### CROSS-REFERENCE TO RELATED APPLICATIONS

This application is a continuation application of the International application PCT/CN2018/120732, filed on Dec. 12, 2018, entitled “DATA PROCESSING METHOD, CIRCUIT, TERMINAL DEVICE AND STORAGE MEDIUM”, the content of which is hereby incorporated by reference in its entirety.

### TECHNICAL FIELD

The present disclosure relates to the field of data processing and, in particular to a data processing method, a circuit, a terminal device, and a storage medium.

### BACKGROUND

With the rapid development of information technology, more and more embedded system-on-a-chip (SoC) products use an external flash (FLASH) to store data such as program codes to reduce product costs.

In order to achieve security of data, it is necessary to encrypt the data stored in the external FLASH. Accordingly, for an SoC chip with a locally-loaded-code-program execute in place (XIP) function, it is required to directly load data from the external FLASH during the power-on or operating of the chip and decrypt the loaded data quickly, and to load the decrypted data into a cache (cache) for execution by a microcontroller unit (MCU). Therefore, data decryption delay is an important performance to measure the quality of products, and the technical problem to be solved urgently in the field is how to decrypt data to reduce the data decryption delay.

### SUMMARY

The present disclosure provides a data processing method, a circuit, a terminal device, and a storage medium, so as to reduce data decryption delay.

In a first aspect, the present disclosure provides a data processing method, including: generating a decryption keystream of first data according to a physical start address of the first data before or during reading the first data from a flash; and decrypting the first data through the decryption keystream and writing the decrypted first data into a cache.

Base on this, as long as the data processing circuit acquires the first data, the decryption keystream of the first data has already been pre-generated, so that the data processing circuit can directly decrypt the first data, thus reducing the data decryption delay.

Optionally, when the first data is the initial first data, a logical start address of the initial first data is acquired from a microcontroller unit MCU and the physical start address of the initial first data is determined according to the logical start address; when the first data is non-initial first data, the physical start address of the non-initial first data is determined according to the physical start address of the initial first data and an offset between the physical start address of the non-initial first data and the physical start address of the initial first data. The method can effectively determine the physical start address of the first data.

Optionally, it is determined that the first data is the initial first data when a first enable signal is received; it is determined that the first data is non-initial first data when a second enable signal is received, where the first enable signal is different from the second enable signal.

Optionally, the decrypting the first data through the decryption keystream includes: performing an XOR operation on the decryption keystream and the first data to decrypt the first data, when a length of the decryption keystream and a length of the first data are the same; performing an extraction on the decryption keystream in accordance with the length of first data and performing the XOR operation on the decryption keystream obtained after the extraction and the first data to decrypt the first data, when the length of the decryption keystream is greater than the length of the first data.

In this embodiment, the data processing circuit can decrypt the first data by performing the XOR operation in way of stream encryption on the decryption keystream and the first data. Since the XOR operation is a combinational circuit, the decryption delay of data may be further reduced in this way.

Optionally, the method further includes: generating an encryption keystream of second data according to a physical start address of the second data; and encrypting the second data through the encryption keystream and writing the encrypted second data into the flash.

In this embodiment, for the same data, the corresponding encryption keystream thereof is the same as the decryption keystream thereof, that is, the synchronization of the encryption key and decryption key is realized.

Optionally, when the second data is the initial second data, a logical start address of the initial second data is acquired from an MCU and the physical start address of the initial second data is determined according to the logical start address; when the second data is non-initial second data, the physical start address of the non-initial second data is determined according to the physical start address of the initial second data and an offset between physical start address of the non-initial second data and the physical start address of the initial second data. The method can effectively determine the physical start address of the second data.

Optionally, the encrypting the second data through the encryption keystream includes: performing an XOR operation on the encryption keystream and the second data to encrypt second data when a length of encryption keystream and a length of second data are the same; performing an extraction on the encryption keystream in accordance with the length of the second data and performing the XOR operation on the encryption keystream obtained after the extraction and the second data to encrypt the second data when the length of the encryption keystream is greater than the length of the second data.

In this embodiment, the data processing circuit can decrypt the second data by performing the XOR operation on the encryption keystream and the second data. Since the XOR operation is a combinational circuit, data encryption efficiency can be improved in this way.

In a second aspect, the present disclosure provides a data processing circuit, including:

a first generating module, configured to generate a decryption keystream of first data according to a physical start address of the first data before or during reading first data from a flash;

a decryption module, configured to decrypt the first data through the decryption keystream and write the decrypted first data into a cache.

In a third aspect, the present disclosure provides a data processing circuit, including: a processor; a memory, configured to store instructions executable by the processor to cause the processor to execute the data processing method according to the first aspect or optional implementations of the first aspect.

In a fourth aspect, the present disclosure provides a terminal device, including: the data processing circuit according to the second aspect or the third aspect, an MCU and a flash. Two ends of the data processing circuit are respectively connected with the MCU and the flash.

In a fifth aspect, the present disclosure provides a storage medium, including: executable instructions, which are used to implement the data processing method according to the first aspect or optional implementations of the first aspect.

In a sixth aspect, the present disclosure provides a computer program product, including: executable instructions, configured to implement the data processing method according to the first aspect or optional implementations of the first aspect.

The present disclosure provides a data processing method, a circuit, a terminal device, and a storage medium. Where, the data processing circuit can generate the decryption keystream of the first data according to the physical start address of the first data before or during reading the first data from the flash. Base on this, as long as the data processing circuit acquires the first data, the decryption keystream of the first data has already been pre-generated, so that the data processing circuit can directly decrypt the first data, thus reducing the data decryption delay. Optionally, in this embodiment, the data processing circuit can decrypt the first data by performing XOR operation on the decryption keystream and the first data. Since the XOR operation is a combinational circuit, the data decryption delay may be further reduced in this way.

### BRIEF DESCRIPTION OF DRAWINGS

To describe the technical solutions in embodiments of the present disclosure or in the prior art more clearly, the following briefly introduces the accompany drawings needed for describing the embodiments or the prior art. Apparently, the accompanying drawings in the following description illustrate merely some embodiments of the present disclosure, and those of ordinary skill in the art may still derive other drawings from these accompanying drawings without creative effort.

FIG. 1 is a schematic diagram of an embedded SoC chip and an external FLASH provided in the prior art;

FIG. 2 is a flowchart of a data processing method provided in an embodiment of the present disclosure;

FIG. 3 is a schematic diagram of instruction and data transmission provided in an embodiment of the present disclosure;

FIG. 4 is a schematic diagram of internal modules and data processing flow of a flash controller provided in an embodiment of the present disclosure;

FIG. 5 is a flowchart of a data processing method provided in another embodiment of the present disclosure;

FIG. 6 is a schematic diagram of internal modules and a data processing flow of a flash controller provided in another embodiment of the present disclosure;

FIG. 7 is a schematic diagram of a data processing circuit provided in an embodiment of the present disclosure; and

FIG. 8 is a schematic diagram of an embedded SoC chip and an external FLASH provided in an embodiment of the present disclosure.

### DESCRIPTION OF EMBODIMENTS

To make the objectives, technical solutions, and advantages of embodiments of the present disclosure clearer, the following clearly and comprehensively describes the technical solutions in embodiments of the present disclosure with reference to the accompanying drawings in embodiments of the present disclosure. Apparently, the described embodiments are merely a part rather than all embodiments of the present disclosure. All other embodiments obtained by those of ordinary skill in the art based on embodiments of the present disclosure without creative effort shall fall within the protection scope of the present disclosure.

The terms “first”, “second”, “third”, “fourth” and etc. (if present) in the description, claims and the above accompanying drawings of the present disclosure are used to distinguish similar objects, and not necessarily used to describe a specific order or sequence. It should be understood that the terms used in this way can be interchanged under appropriate circumstances, so that the embodiments of the present disclosure described herein can be implemented in an order other than those illustrated or described herein, for example.

Furthermore, the terms “including” and “comprising” as well as any variations thereof are intended to cover non-exclusive inclusions. For example, processes, methods, systems, products or devices including a series of steps or units are not be limited to those steps or units explicitly listed, but may include other steps or units not explicitly listed or inherent to these processes, methods, products or devices.

Before technical solutions of the present disclosure being introduced, the following first introduces an embedded SoC chip and an external FLASH.

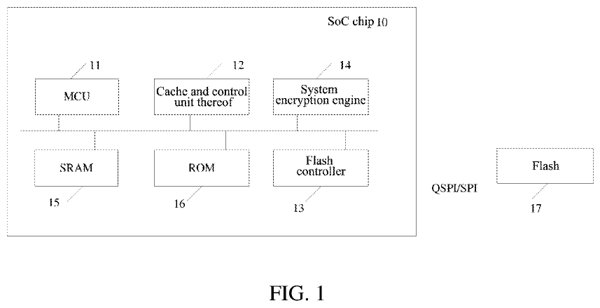

FIG. 1 is a schematic diagram of an embedded SoC chip and an external FLASH provided in the prior art. As shown in FIG. 1, the SoC chip 10 includes:

a microcontroller unit (MCU) 11: a core controller of the embedded SoC chip, configured to run data such as code programs;

a cache (Cache) and a control unit 12 of the cache: a code program can run at high speed in the MCU 11 when the code program is cached, where the code program comes from an on-chip static random-access memory (SRAM) and/or the external FLASH;

a flash controller 13: configured to read and write data in the external FLASH, and generally access the FLASH in the way of a quad serial peripheral interface (QSPI) or a serial peripheral interface (SPI);

a system encryption engine 14: configured to encrypt data by adopting the same encryption mechanism as decryption, and write the encrypted data into the FLASH via QSPI or SPI through the flash controller 13;

an on-chip SRAM 15: configured to store data such as program codes;

a read-only memory (ROM) 16: configured to store programs for execution by the SoC chip when the SoC chip is powered on;

a QSPI/SPI: configured to realize data transmission between the flash controller 13 and the FLASH;

in addition, an external FLASH 17: configured to store data such as code programs for the SoC chip to read and write data in the FLASH.

As mentioned above, in order to achieve security of data, it is necessary to encrypt the data stored in the external FLASH. Accordingly, for the SoC chip with the XIP function, it is required to directly load data from the external FLASH during the power-on or operating of the chip and decrypt the loaded data quickly, and to load the decrypted data into the cache for execution by the MCU. Therefore, the technical problem to be solved urgently by the present disclosure is how to decrypt data to reduce the data decryption delay.

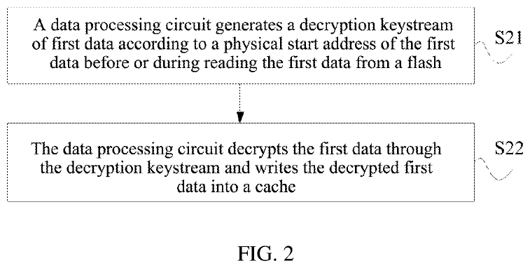

To solve the above technical problem, the present disclosure provides a data processing method, a circuit, a terminal device, and a storage medium. Specifically, FIG. 2 is a flowchart of a data processing method provided in an embodiment of the present disclosure. The executive entity of the method may be a data processing circuit or a terminal device. The data processing circuit may be integrated in an SoC chip, for example, the circuit is integrated in a flash controller, or the circuit is a flash controller or an SoC chip, which is not limited in the present disclosure. The data processing circuit is taken as the executive entity of the method to exemplify. As shown in FIG. 2, the method includes the following steps:

S21: the data processing circuit generates a decryption keystream of first data according to a physical start address of the first data before or during reading the first data from a flash;

S22: the data processing circuit decrypts the first data through the decryption keystream and writing the decrypted first data into a cache.

S21 is described as follows.

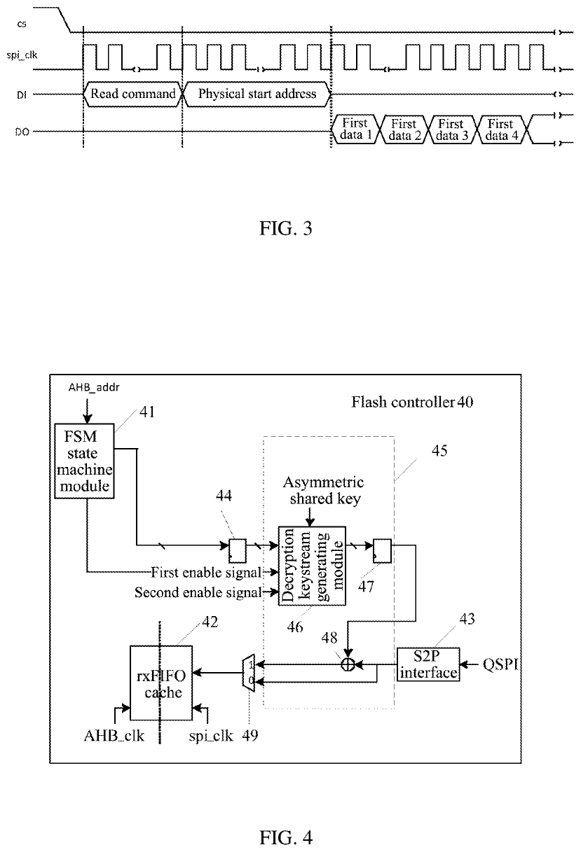

This embodiment is applied to the scenario where the data processing circuit reads data from the flash. As mentioned above, in order to achieve the security of data, the data in the flash is encrypted, so the first data needs to be decrypted after the data processing circuit reading the first data from the flash. In order to reduce the data decryption delay, this embodiment proposes to generate the decryption keystream of the first data before reading or during reading the first data from the flash, where each of the first data has a unique decryption keystream. For example, FIG. 3 is a schematic diagram of instruction and data transmission provided in an embodiment of the present disclosure. As shown in FIG. 3, the data processing circuit sends a read command and a physical start address of initial first data to the FLASH before reading the initial first data, in which the data processing circuit can generate a decryption keystream of each of the first data in advance during the process of sending the read command and the physical start address of the initial first data to the FLASH.

In this embodiment, the data processing circuit can generate the decryption keystream of the first data according to the physical start address of the first data, where the physical start address of the first data refers to the physical start address of the first data in the flash.

The data processing circuit acquires the physical start address of the first data in different ways for different first data. Optionally, when the first data is the initial first data, the data processing circuit acquires a logical start address of the first data from the MCU, and determines the physical start address of the first data according to the logical start address. When the first data is not the initial first data (i.e. when the first data is non-initial first data), the data processing circuit determines the physical start address of the non-initial first data according to the physical start address of the initial first data and an offset between the physical start address of the non-initial first data and the physical start address of the initial first data. For example, if the physical start address of the first data is addr, and the offset between the physical start address of another first data and the physical start address of the initial first data is 4, then the physical start address of the another first data is addr+4. Or, when the first data is non-initial first data, the data processing circuit can also acquire the logical start address of the non-initial first data from the MCU, and determine the physical start address of the non-initial first data according to the logical start address.

Further, for one piece of the first data, whether the first data is the initial first data may be determined in the following optional way. Optionally, when the data processing circuit receives a first enable signal, it is determined that the first data is the initial first data; when the data processing circuit receives a second enable signal, it is determined that the first data is non-initial first data. Optionally, the first enable signal is an initial address access enable signal (spi_addr_start), which is used to indicate that the first data is the initial first data, and to indicate to start the generation of the decryption keystream of the initial first data. The second enable signal is an FIFO write enable signal (FIFO_wr), which is used to indicate that the first data is non-initial first data, or to indicate to start the generation of the decryption keystream of the non-initial first data. The so-called “write” here refers to writing the data in the FLASH into the cache. For example, the first enable signal is 1 and the second enable signal is 0, or the first enable signal is 0 and the second enable signal is 1. The first enable signal and the second enable signal are not limited in this embodiment.

Optionally, the way in which the data processing circuit generates the decryption keystream of the first data includes any one of the following but is not limited thereto.

An optional method: the data processing circuit acquires a public key and generates an asymmetric shared key according to the public key, where the data processing circuit may generate the asymmetric shared key by using the existing RSA algorithm, which is not explained in this embodiment. Further, the data processing circuit may acquire an original vector, where the original vector includes some information which can be public, and the public information is used to generate the decryption keystream of the first data, for example, the public information includes random numbers. Finally, the data processing circuit may take the physical start address of the first data and the original vector as plaintext in a Counter (CTR) mode, and take the asymmetric shared key as a key in the CTR mode, so as to generate the decryption keystream of the first data.

Another optional method: the data processing circuit directly applies a certain algorithm to the physical start address of the first data to acquire the decryption keystream of the first data. For example, the data processing circuit extracts the last 8 bits of the physical start address of the first data as the decryption keystream of the first data. Or, the data processing circuit selects odd bits or even bits of the physical start address of the first data as the decryption keystream of the first data. Or, the data processing circuit selects odd bits or even bits of the physical start address of the first data firstly, and then performs operations, such as summation, quadrature, on the odd bits or even bits to acquire the decryption keystream of the first data.

S22 is described as follows.

Optionally, when a length of the decryption keystream and a length of the first data are the same, an XOR operation is performed on the decryption keystream and the first data to decrypt the first data; when the length of the decryption keystream is greater than the length of the first data, an extraction is performed on the decryption keystream in accordance with the length of first data, and the XOR operation is performed on the decryption keystream obtained after the extraction and the first data to decrypt the first data. For example, usually the first data is a data block with the length of 4 bytes (that is, 32 bits). Assuming that the decryption keystream is also 32 bits, the data processing circuit may directly perform the XOR operation on the decryption keystream and the first data to decrypt the first data. Assuming that the decryption keystream is 64 bits, the data processing circuit may extract the first 32 bits or the last 32 bits of the decryption keystream, and perform the XOR operation on the decryption keystream obtained after the extraction and the first data to decrypt the first data.

Further, the data processing circuit decrypts the first data through the decryption keystream, and then writes the decrypted first data into the cache for the MCU to execute the first data.

In this embodiment, the data processing circuit may generate the decryption keystream of the first data according to the physical start address of the first data before or during reading the first data from the flash. Base on this, as long as the data processing circuit acquires the first data, the decryption keystream of the first data has already been acquired, so that the data processing circuit may directly decrypt the first data, which thus can reduce data decryption delay. Optionally, in this embodiment, the data processing circuit may perform the XOR operation on the decryption keystream and the first data to decrypt the first data. Since the XOR operation is a combinational circuit, the data decryption delay can be further reduced in this way.

As mentioned above, the above data processing circuit may be integrated on an SoC chip, for example, the chip is integrated in the flash controller; or the data processing circuit is a flash controller or an SoC chip. Assuming that the data processing circuit is a circuit integrated in the flash controller, in fact, there are other modules in the flash controller. The above data processing method will be further described through the interaction between these modules and the data processing circuit.

FIG. 4 is a schematic diagram of internal modules and data processing flow of a flash controller provided in an embodiment of the present disclosure. As shown in FIG. 4, the flash controller 40 includes: a finite state machine (FSM) module 41, a receive first input first output (rxFIFO) cache 42, a serial to parallel (S2P) interface 43, a first register 44, a data processing circuit 45 and a selector 49; where the data processing circuit 45 includes: a decryption keystream generating module 46, a second register 47, and an XOR operation module 48. For initial first data, the FSM module 41 can receive a logical start address AHB_addr of the initial first data and convert the logical start address AHB_addr into a physical start address, and transmit the physical start address of the initial first data to the decryption keystream generating module 46 in the data processing circuit 45 and send a first enable signal spi_addr_start to the decryption keystream generating module 46. For non-initial first data, the FSM module 41 can acquire a physical start address of the non-initial first data by calculating according to the physical start address of the initial first data and an offset between the physical start address of the non-initial first data and the physical start address of the initial first data, and then transmit the physical start address of the non-initial first data to the decryption keystream generating module 46 in the data processing circuit 45 and send the above-mentioned second enable signal FIFO_wr to the decryption keystream generating module 46. Optionally, the data processing circuit 45 may send the physical start address of the first data to the decryption keystream generating module 46 through the first register 44, where the first register 44 is configured to implement clock synchronization between the flash controller 40 and the FLASH. Optionally, assuming that the decryption keystream of the first data is determined in the CTR mode in this embodiment, the decryption keystream generating module 46 may first acquire an asymmetric shared key and an original vector of the first data, and the data processing circuit may take the physical start address and the original vector of the first data as plaintext in the CTR mode, and then take the asymmetric shared key as the key in the CTR mode to generate the decryption keystream of the first data. Optionally, the decryption keystream generating module 46 may transmit the generated decryption keystream to the second register 47, where the second register 47 is also configured to implement the clock synchronization between the flash controller 40 and the FLASH. The second register 47 transmits the decryption keystream to the XOR operation module 48. On the other hand, the S2P module 49 in the data processing circuit 45 may read the first data from the FLASH through QSPI, where the S2P module 49 is configured to implement serial-to-parallel conversion, and the XOR operation module 48 may perform an XOR operation on the decryption keystream and the first data, that is, decrypt data to be interpreted. Optionally, the XOR operation module 48 may output the decrypted first data to the selector 49, so that the selector 49 only sends the decrypted first data to the rxFIFO cache 42, where the rxFIFO cache 42 needs to implement the clock synchronization between the flash controller 40 and the FLASH. At last, the rxFIFO cache 42 may write the decrypted first data into the cache through a bus (e.g., AHB bus) for the MCU to execute the decrypted first data.

The above modules and the data processing circuit can be understood as software modules, or as hardware circuits, which is not limited in this embodiment.

In this embodiment, the above data processing method is further described by dividing the flash controller into modules and through the interaction of the modules with the data processing circuit, where the data processing circuit generates the decryption keystream of the first data according to the physical start address of the first data before or during reading the first data from the flash. Based on this, as long as the data processing circuit acquires the first data, the decryption keystream of the first data has already been pre-generated, so that the data processing circuit may directly decrypt the first data, which thus reduces data decryption delay. Optionally, in this embodiment, the data processing circuit may perform the XOR operation on the decryption keystream and the first data to decrypt the first data. Since the XOR operation is a combinational circuit, the data decryption delay may be further reduced in this way.

The data reading process or data decryption process has been described above, and the data writing process or data encryption process will be described below.

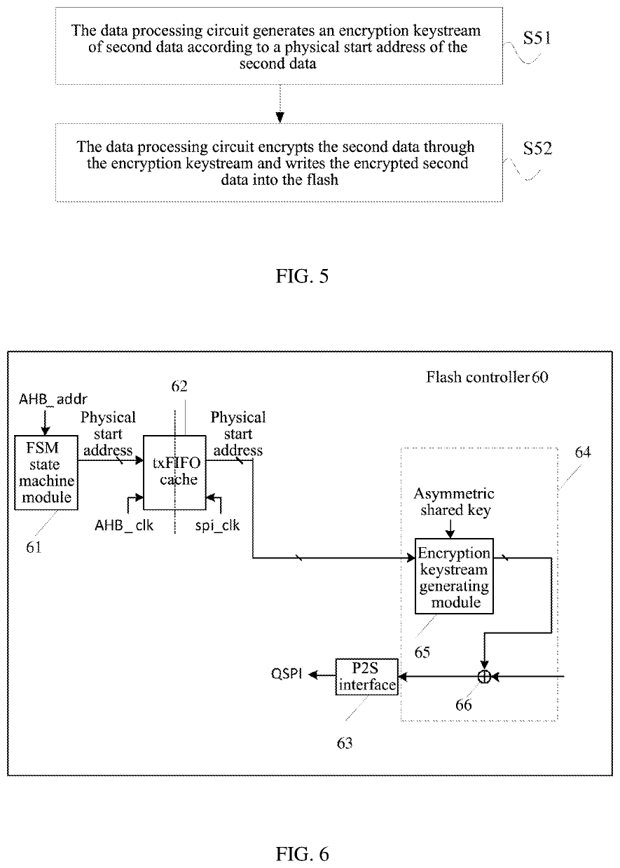

FIG. 5 is a flowchart of a data processing method provided in another embodiment of the present disclosure, the executive subject of the method may be a data processing circuit or a terminal device. The data processing circuit may be integrated in the SoC chip, for example, the circuit is integrated in the flash controller, or the circuit is the flash controller or the SoC chip, which is not limited in the present disclosure. In the following, the executive subject of the method is a data processing circuit, for example. As shown in FIG. 5, the method includes the following steps:

S51: the data processing circuit generates an encryption keystream of second data according to a physical start address of the second data.

S52: the data processing circuit encrypts the second data through the encryption keystream, and writes the encrypted second data into the flash

S51 is described as follows:

This embodiment is applied to the scenario where the data processing circuit writes data into the flash. As mentioned above, in order to achieve security of data, the data in the flash is encrypted, so the data needs to be encrypted when the data processing circuit accesses the data to the flash, where each of the second data has a unique encryption keystream.

In this embodiment, the data processing circuit can generate the encryption keystream of the second data according to the physical start address of the second data, where the physical start address of the second data refers to the physical start address of the second data in the flash.

For different second data, the data processing circuit acquires the physical start address of the second data in different ways. Optionally, when the second data is the initial second data, the data processing circuit acquires a logical start address of the second data from the MCU, and determines the physical start address of the second data according to the logical start address. When the second data is non-initial second data, the data processing circuit determines the physical start address of the non-initial second data according to the physical start address of the initial second data and an offset between the physical start address of the non-initial second data and that of the initial second data. For example, if the physical start address of the initial second data is addr, and the offset between the physical start address of another second data and the physical start address of the initial second data is 4, then the physical start address of the another second data is addr+4. Or, when the second data is non-initial second data, the data processing circuit can also acquire the logical start address of the non-initial second data from the MCU, and determine the physical start address of the non-initial second data according to the logical start address.

Optionally, the way in which the data processing circuit generates the encryption keystream of the second data includes any one of the following but is not limited thereto.

An optional method: the data processing circuit acquires a public key and generates an asymmetric shared key according to the public key, where the data processing circuit may generate the asymmetric shared key by using the existing RSA algorithm, which is not explained in this embodiment. Further, the data processing circuit may acquire an original vector, which includes some information can be public, and the public information is used to generate the encryption keystream of the second data, for example, the public information includes random numbers. Finally, the data processing circuit may take the physical start address of the second data and the original vector as plaintext in the CTR mode, and take the asymmetric shared key as key in the CTR mode, so as to generate the encryption keystream of the second data.

Another optional method: the data processing circuit directly applies certain algorithm to the physical start address of the second data to acquire the encryption keystream of the second data. For example, the data processing circuit extracts the last 8 bits of the physical start address of the second data as the encryption keystream of the second data. Or, the data processing circuit selects odd bits or even bits of the physical start address of the second data as the encryption keystream of the second data. Or, the data processing circuit selects odd bits or even bits of the physical start address of the second data firstly, and then performs operations such as summation, quadrature on the odd bits or even bits to acquire the encryption keystream of the second data.

It should be noted that the way in which the data processing circuit generates the encryption keystream is the same as the way in which the data processing circuit generates the decryption keystream.

S52 is described as follows:

Optionally, when a length of the encryption keystream and a length of the second data are the same, an XOR operation is performed on the encryption keystream and the second data to encrypt the second data; when the length of the encryption keystream is greater than the length of the second data, an extraction is performed on the encryption keystream in accordance with the length of the second data, and the XOR operation is performed on the encryption keystream obtained after the extraction and the second data to encrypt the second data. For example, usually the second data is a data block with the length of 4 bytes (that is, 32 bits). Assuming that the encryption keystream is also 32 bits, the data processing circuit may directly perform the XOR on the encryption keystream and the second data to encrypt the second data. Assuming that the encryption keystream is 64 bits, the data processing circuit may extract the first 32 bits or the last 32 bits of the encryption keystream, and perform the XOR operation on the encryption keystream obtained after the extraction and the second data to encrypt the second data.

It should be noted that the encryption process of the second data by the data processing circuit corresponds to the decryption process of the data. For example, for the same data, the data processing circuit performs the XOR operation on the data and encryption keystream, also, the data processing circuit performs the XOR operation on the data and the decryption keystream.

In this embodiment, for the same data, the corresponding encryption keystream thereof is the same as the decryption keystream thereof, that is, the synchronization of the encryption key and decryption key is realized.

As mentioned above, the data processing circuit above may be integrated in an SoC chip, for example, the data processing circuit is integrated in a flash controller, or the data processing circuit is a flash controller or the SoC chip. Assuming that the data processing circuit is a circuit integrated in the flash controller, in fact, there are other modules in the flash controller. The above data processing method will be further described through the interaction between these modules and the data processing in the following circuit.

FIG. 6 is a schematic diagram of the internal modules and data processing flow of a flash controller provided in another embodiment of the present disclosure. As shown in FIG. 6, the flash controller 60 includes: a FSM module 61, a transmit first input first output (txFIFO) cache 62, a parallel to serial (P2S) interface 63, and a data processing circuit 64; where the data processing circuit 64 includes an encryption keystream generating module 65 and an XOR operation module 66. For initial second data, the FSM module 61 can receive a logical start address AHB_addr of the initial second data, and convert the logical start address AHB_addr into a physical start address, and transmit the physical start address of the initial second data to the txFIFO cache 62, which is configured to implement the clock synchronization between the flash controller 40 and the FLASH. The txFIFO cache 62 transmits the physical start address of the initial second data to the encryption keystream generating module 65 in the data processing circuit. For the non-initial second data, the FSM module 61 can acquire a physical start address of the non-initial second data by calculating according to the physical start address of the initial second data and the offset between the physical start address of the non-initial second data and the physical start address of the initial second data, and then transmit the physical start address of the non-initial second data to the encryption keystream generating module 65 in the data processing circuit 64. Optionally, assuming that the encryption keystream of the second data is determined in the CTR mode in this embodiment, the encryption keystream generating module 65 may first acquire an asymmetric shared key and an original vector of the second data, and the data processing circuit may take the physical start address and the original vector of the second data as plaintext in the CTR mode, and then take the asymmetric shared key as the key in the CTR mode to generate the encryption keystream of the second data. The encryption keystream generating module 65 transmits the encryption keystream to the XOR operation module 66, the XOR operation module 66 may perform an XOR operation on the encryption keystream and the second data, that is, encrypt the second data. On the other hand, the P2S interface 63 in the data processing circuit may write the second data into the FLASH in way of QSPI, where the P2S interface 63 is configured to implement parallel-to-serial conversion.

The above modules and data processing circuits may be understood as software modules, or as hardware circuits, which is not limited in this embodiment.

It should be noted that the data processing circuit 64 in this embodiment may be integrated with the data processing circuits involved in the above data reading process.

In this embodiment, the data processing method above is further described by dividing the flash controller into modules and through the interaction of these modules with the data processing circuit.

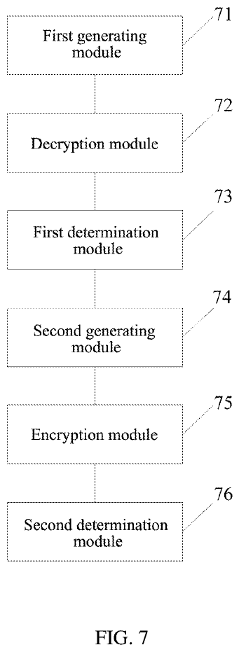

FIG. 7 is a schematic diagram of a data processing circuit provided in an embodiment of the present disclosure. Optionally, the data processing circuit is a circuit in a flash controller, a flash controller, or a system-on-a-chip SoC. As shown in FIG. 7, the data processing circuit includes:

a first generating module 71, configured to generate a decryption keystream of first data according to a physical start address of the first data before or during reading the first data from a flash;

a decryption module 72, configured to decrypt the first data through the decryption keystream, and write the decrypted first data into a cache.

Optionally, the circuit further includes: a first determination module 73, configured to: when the first data is initial first data, acquire a logical start address of the first data from an MCU and determine a physical start address of the first data according to the logical start address; when the first data is non-initial first data, determine the physical start address of the non-initial first data according to the physical start address of the initial first data and an offset between the physical start address of the non-initial first data and the physical start address of the initial first data.

Optionally, the first determination module 73 is specifically configured to: determine that the first data is the initial first data when a first enable signal is received; and determine that the first data is the non-initial first data when a second enable signal is received.

Optionally, the first determination module 73 is specifically configured to: perform an XOR operation on the decryption keystream and the first data to decrypt the first data, when a length of the decryption keystream and a length of the first data are the same; and perform an extraction on the decryption keystream in accordance with the length of the first data and perform the XOR operation on the decryption keystream obtained after the extraction and the first data to decrypt the first data when the length of the decryption keystream is greater than that the length of the first data.

Optionally, the circuit further includes:

a second generating module 74, configured to generate an encryption keystream of the second data according to a physical start address of the second data;

an encryption module 75, configured to encrypt the second data through the encryption keystream and write the encrypted second data into the flash.

Optionally, the circuit further includes: a second determination module 76, configured to: when the second data is initial second data, acquire a logical start address of the initial second data from an MCU and determine the physical start address of the initial second data according to the logical start address; when the second data is non-initial second data, determine the physical start address of the non-initial second data according to the physical start address of the initial second data and an offset between the physical start address of the non-initial second data and the physical start address of the initial second data.

Optionally, the encryption module 75 is specifically configured to: perform an XOR operation on the encryption keystream and the second data to encrypt the second data when a length of the encryption keystream and a length of the second data are the same; perform an extraction on the encryption keystream in accordance with the length of the second data and perform the XOR operation on the encryption keystream obtained after the extraction and the second data to encrypt the second data when the length of the encrypted keystream is greater than the length of the second data.

The above modules can be understood as software modules, or as hardware circuits.

The first generating module 71 is equivalent to the decryption keystream generating module 46 in FIG. 4; the decryption module 72 is equivalent to the XOR operation module 48 in FIG. 4; the first determination module 73 is equivalent to the FSM module 41 in FIG. 4; the second generating module 74 is equivalent to the encryption keystream generating module 65 in FIG. 6; the encryption module 75 is equivalent to the XOR operation module 66 in FIG. 6; and the second determination module 76 is equivalent to the FSM module 61 in FIG. 6, where FSM module 41 and FSM module 61 may be the same FSM module.

The data processing circuit provided in this embodiment may execute the above data processing method, and for contents and effects thereof, the method parts may be referred to. Furthermore, the data processing circuits provided in embodiments of the present disclosure may be modularly designed with simple structure, and thus can be integrated into the flash controller.

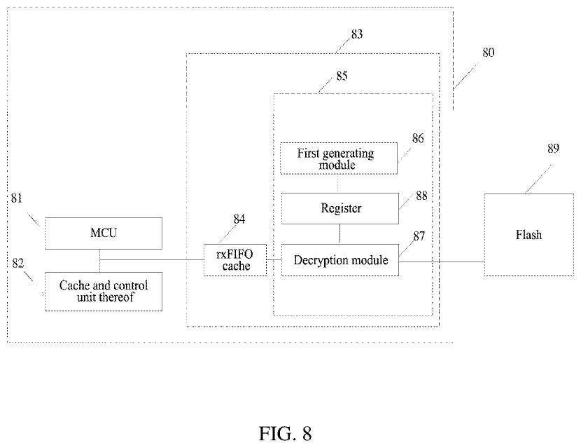

As mentioned above, the above modules and data processing circuits may be understood as software modules or hardware circuits. Assuming that these modules are hardware circuits, further, FIG. 8 is a schematic diagram of an embedded SoC chip and an external FLASH provided in an embodiment of the present disclosure. As shown in FIG. 8, the SoC chip 80 includes an MCU 81, a cache and a control unit 82 of the cache, and a FLASH controller 83, where the FLASH controller 83 includes a rxFIFO cache 84 and a data processing circuit 85; the data processing circuit 85 includes a first generating module 86 and a decryption module 87. Optionally, the data processing circuit 85 further includes a register 88. The MCU 81 is connected with the cache and the control unit 82 of the cache, and the FLASH controller 83 through a bus (e.g. AHB bus), specifically connected with the rxFIFO cache 84; the first generating module 86 is connected with the decryption module 87 through the register 88, and the decryption module 87 is connected with a flash 89; where the MCU 81, the cache and the control unit 82 of the cache, and the Flash controller 83 may refer to corresponding embodiment in FIG. 1, the rxFIFO cache 84 may refer to corresponding embodiment in FIG. 4, the first generating module 86 and the decryption module 87 may refer to corresponding embodiment in FIG. 7, which the contents and effects will not be repeated here.

The present disclosure also provides a data processing circuit, which includes a processor; a memory configured to store instructions executable by the processor to cause the processor to execute the above the data processing method, the memory may be a non-volatile storage medium, and its contents and effects may be referred to the method part, which will not be repeated here.

The present disclosure also provides a terminal device, which includes the data processing circuits described above, an MCU and a flash; where two ends of the data processing circuit are connected with the MCU and the flash respectively. The data processing circuit may be configured to execute the above data processing methods, and for contents and effects thereof, the method parts can be referred to, which will not be described here.

Persons of ordinary skill in the art can understand that all or part of the steps for implementing the above-mentioned method embodiments can be completed by hardware related to program instructions. The aforementioned program can be stored in a computer readable storage medium. When the program is executed, the steps including the above method embodiments are executed. The aforementioned storage media include a ROM, a RAM, a magnetic disk or an optical disk and etc., which can store program codes.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent substitutions to some technical features thereof, without departing from the spirit and scope of the technical solutions of embodiments of the present disclosure.

What is claimed is:

1. A data processing method, comprising:
generating a decryption keystream of first data according to a physical start address of the first data before or during reading the first data from a flash; and
decrypting the first data through the decryption keystream and writing the decrypted first data into a cache.

2. The method according to claim 1, further comprising:
when the first data is initial first data, acquiring a logical start address of the initial first data from a microcontroller unit (MCU) and determining the physical start address of the initial first data according to the logical start address; and
when the first data is non-initial first data, determining the physical start address of the non-initial first data according to the physical start address of the initial first data and an offset between the physical start address of the non-initial first data and the physical start address of the initial first data.

3. The method according to claim 2, further comprising:
determining that the first data is the initial first data when a first enable signal is received; and
determining that the first data is non-initial first data when a second enable signal is received, wherein the first enable signal is different from the second enable signal.

4. The method according to claim 1, wherein the decrypting of the first data through the decryption keystream comprises:
performing an XOR operation on the decryption keystream and the first data to decrypt the first data, when a length of the decryption keystream and a length of the first data are the same; and
performing an extraction on the decryption keystream in accordance with the length of the first data and performing the XOR operation on the decryption keystream obtained after the extraction and the first data to decrypt the first data, when the length of the decryption keystream is greater than the length of the first data.

5. The method according to claim 1, further comprising:
generating an encryption keystream of second data according to a physical start address of the second data; and
encrypting the second data through the encryption keystream and writing the encrypted second data into the flash.

6. The method according to claim 5, further comprising:
when the second data is initial second data, acquiring a logical start address of the initial second data from an MCU and determining the physical start address of the initial second data according to the logical start address; and
when the second data is non-initial second data, determining the physical start address of the non-initial second data according to the physical start address of the initial second data and an offset between the physical start address of the non-initial second data and the physical start address of the initial second data.

7. The method according to claim 5, wherein the encrypting of the second data through the encryption keystream comprises:
performing an XOR operation on the encryption keystream and the second data to encrypt the second data, when a length of the encryption keystream and a length of the second data are the same;
performing an extraction on the encryption keystream in accordance with the length of the second data and performing the XOR operation on the encryption keystream obtained after the extraction and the second data to encrypt the second data, when the length of the encrypted keystream is greater than the length of the second data.

8. A data processing circuit, comprising:
a processor; and
a memory configured to store instructions executable by the processor to cause the processor to execute the following steps:
generating a decryption keystream of first data according to a physical start address of the first data before or during reading the first data from a flash; and
decrypting the first data through the decryption keystream and writing the decrypted first data into a cache.

9. The circuit according to claim 8, wherein the processor is further caused to execute the following steps:
when the first data is initial first data, acquiring a logical start address of the initial first data from a microcontroller unit (MCU) and determining the physical start address of the initial first data according to the logical start address; and
when the first data is non-initial first data, determining the physical start address of the non-initial first data according to the physical start address of the initial first data and an offset between the physical start address of the non-initial first data and the physical start address of the initial first data.

10. The circuit according to claim 9, wherein the processor is further caused to execute the following steps:
determining that the first data is the initial first data when a first enable signal is received; and
determining that the first data is non-initial first data when a second enable signal is received, wherein the first enable signal is different from the second enable signal.

11. The circuit according to claim 8, wherein the processor is further caused to execute the following steps:
performing an XOR operation on the decryption keystream and the first data to decrypt the first data, when a length of the decryption keystream and a length of the first data are the same; and
performing an extraction on the decryption keystream in accordance with the length of the first data and performing the XOR operation on the decryption keystream obtained after the extraction and the first data to decrypt the first data, when the length of the decryption keystream is greater than the length of the first data.

12. The circuit according to claim 8, wherein the processor is further caused to execute the following steps:
generating an encryption keystream of second data according to a physical start address of the second data; and
encrypting the second data through the encryption keystream and writing the encrypted second data into the flash.

13. The circuit according to claim 12, wherein the processor is further caused to execute the following steps:
when the second data is initial second data, acquiring a logical start address of the initial second data from an MCU and determining the physical start address of the initial second data according to the logical start address; and
when the second data is not the non-initial second data, determining the physical start address of the non-initial second data according to the physical start address of the initial second data and an offset between the physical start address of the non-initial second data and the physical start address of the initial second data.

14. The circuit according to claim 12, wherein the processor is further caused to execute the following steps:
performing an XOR operation on the encryption keystream and the second data to encrypt the second data, when a length of the encryption keystream and a length of the second data are the same;
performing an extraction on the encryption keystream in accordance with the length of the second data and performing the XOR operation on the encryption keystream obtained after the extraction and the second data to encrypt the second data, when the length of the encrypted keystream is greater than the length of the second data.

15. The circuit according to claim 8, wherein the circuit is any one of the following: a circuit in a flash controller, a flash controller, and a system-on-a-chip (SoC).

16. A terminal device, comprising: a data processing circuit, a microcontroller unit (MCU) and a flash;
wherein two ends of the data processing circuit are respectively connected with the MCU and the flash;
wherein the processing circuit comprises: a processor; and a memory, configured to store instructions executable by the processor to cause the processor to execute the following steps:
generating a decryption keystream of first data according to a physical start address of the first data before or during reading the first data from the flash; and
decrypting the first data through the decryption keystream and writing the decrypted first data into a cache.

17. The terminal device according to claim 16, wherein the processor is further caused to execute the following steps:
when the first data is initial first data, acquiring a logical start address of the initial first data from the MCU and determining the physical start address of the initial first data according to the logical start address; and
when the first data is non-initial first data, determining the physical start address of the non-initial first data according to the physical start address of the initial first data and an offset between the physical start address of the non-initial first data and the physical start address of the initial first data.

18. The terminal device according to claim 16, wherein the processor is further caused to execute the following steps:
generating an encryption keystream of second data according to a physical start address of the second data; and
encrypting the second data through the encryption keystream and writing the encrypted second data into the flash.

19. The terminal device according to claim 18, wherein the processor is further caused to execute the following steps:
when the second data is initial second data, acquiring a logical start address of the initial second data from an MCU and determining the physical start address of the initial second data according to the logical start address; and
when the second data is non-initial second data, determining the physical start address of the non-initial second data according to the physical start address of the initial second data and an offset between the physical start address of the non-initial second data and the physical start address of the initial second data.

20. A storage medium, comprising: executable instructions, which are used to implement the data processing method according to claim 1.
